(19) United States
(12) Patent Application Publication
(10) Pub. No.: US 2026/0179988 A1
(43) Pub. Date: Jun. 25, 2026

(54) FUEL CELL SEPARATOR STRUCTURE

(71) Applicants: Hyundai Motor Company, Seoul (KR); Kia Corporation, Seoul (KR)

(72) Inventor: Woo Chul Shin, Hwaseong-si (KR)

(21) Appl. No.: 19/376,556

(22) Filed: Oct. 31, 2025

(30) Foreign Application Priority Data
Dec. 19, 2024 (KR) 10-2024-0190951

(51) Int. Cl. H01M 8/1004; H01M 8/2483

(52) U.S. Cl. CPC H01M 8/1004; H01M 8/2483

(57) ABSTRACT

Disclosed is a fuel cell separator structure. The fuel cel separator structure includes a membrane electrode assembly, a pair of separators disposed to face both side surfaces of the membrane electrode assembly, at least one manifold located on each of the separators so that gas flows through the at least one manifold, fluid inlet holes located adjacent to the at least one manifold to be fluidly connected to the at least one manifold, channels located such that one end of each of the channels faces a corresponding one of the fluid inlet holes, and lands located between the channels and having edges located at ends thereof, and the edges protrude adjacent to the fluid inlet holes based on a boundary configured to face each of gas diffusers of the membrane electrode assembly.

### CROSS-REFERENCE TO RELATED APPLICATIONS

This application claims under 35 U.S.C. §119(a) the benefit of priority from Korean Patent Application No. 10-2024-0190951 filed on December 19, 2024, the entire contents of which are incorporated herein by reference.

### TECHNICAL FIELD

The present disclosure relates to fluid flow control technology. More particularly, it relates to a structure that secures stability of fluid flow by optimizing the design of the boundary between fluid inlet holes and channels, and prevents flow separation to improve the overall system efficiency and performance.

### BACKGROUND

Fuel cells are attracting attention as high-efficiency and eco-friendly energy conversion systems, and a fuel cell stack is a core component that generates power through electrochemical reactions. Efficient flow of a fluid in the fuel cell stack significantly affects the performance and durability of the electrochemical reactions.

Particularly, the design of the boundary between fluid inlet holes and channels is a critical technical element to ensure flow stability and uniformity.

Conventional technologies have employed various design methods to control fluid flow. Attempts to simply connect fluid inlet holes and channels through the boundary therebetween to induce fluid flow, or to optimize fluid distribution through the channel design of a separator have been made. These methods have improved fluid flow to a certain extent and contributed to assisting in transport of mass required for electrochemical reactions.

However, in the case of the conventional structures, the inadequate design of the boundary between the fluid inlet holes and the channels resulted in the following problems. Flow separation occurred at the boundary adjacent to the fluid inlet holes, thus hindering even distribution of the fluid into the channels and causing local flow imbalance. This flow separation increased fluid flow resistance, which increased stack inlet pressure, thus ultimately degrading fuel cell stack performance and durability. On the other hand, water discharge performance was maintained at the outlet of the fuel cell stack, but the flow imbalance problem at the inlet of the fuel cell stack remained unresolved.

Recently, in order to solve the problems of the conventional technologies, research to prevent flow separation and improve uniformity of fluid distribution by optimizing a boundary design between fluid inlet holes and channels has been conducted.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with prior art, and it is an aspect of the present disclosure to provide a fuel cell separator structure that optimizes the boundary between fluid inlet holes and channels to prevent flow separation and enhance the uniformity of fluid distribution.

It is another aspect of the present disclosure to provide a structure that reduces flow resistance at an inlet side and enhances the performance and durability of a fuel cell stack by varying the shape of edges located at the ends of lands.

The aspects of the present disclosure are not limited to the above-described aspects, and other aspects of the present disclosure that are not mentioned may be understood by the following description, and may be more clearly understood from the embodiments of the present disclosure. In addition, the aspects of the present disclosure may be realized by means and combinations thereof disclosed in the claims.

A fuel cell separator structure to achieve the above-described aspects of the present disclosure is configured as follows.

In one aspect, the present disclosure provides a fuel cell separator structure includes a membrane electrode assembly, a pair of separators disposed to face both side surfaces of the membrane electrode assembly, at least one manifold located on each of the separators so that gas flows through the at least one manifold, fluid inlet holes located adjacent to the at least one manifold to be fluidly connected to the at least one manifold, channels located such that one end of each of the channels faces a corresponding one of the fluid inlet holes, and lands located between the channels and having edges located at ends thereof, wherein the edges protrude adjacent to the fluid inlet holes based on a boundary configured to face each of gas diffusers of the membrane electrode assembly.

In an embodiment, the edges may include first edges located at one end of each of the lands, and second edges located at a remaining end of each of the lands.

In another embodiment, the first edges may be located to face the fluid inlet holes.

In still another embodiment, each of the first edges may include a curved portion located at an end of each of the first edges and having a curvature value, a first extension configured to extend from one side of the curved portion toward one side of a corresponding one of the lands, and a second extension configured to extend from the other side of the curved portion toward the other side of the corresponding one of the lands.

In yet another embodiment, the first extension and the second extension may have a predetermined curvature value.

In still yet another embodiment, the first extension may include a first inclined portion configured to extend to the one side of the corresponding one of the lands at a designated angle of inclination along a curvature of the curved portion, and the first inclined portion may be inclined to be parallel to a flow direction of gas flowing into the channels.

In a further embodiment, the second extension may include a second inclined portion configured to extend to the other side of the corresponding one of lands at a designated angle of inclination along a curvature of the curved portion, and the second inclined portion may be inclined to face a flow direction of gas flowing into the channels.

In another further embodiment, the lands may be configured such that the first edges including the first inclined portion or the second inclined portion are arranged alternately.

In still another further embodiment, the at least one manifold may include a fluid inlet configured such that a fluid is introduced thereinto, and a fluid outlet located diagonally to the fluid inlet with respect to the separator and configured such that the fluid is discharged from the fluid outlet, the fuel cell separator structure may include fluid outlet holes located adjacent to the fluid outlet to be fluidly connected to the fluid outlet, and the second edges may be located to face the fluid outlet holes.

In yet another further embodiment, a distance between the first edges and the fluid inlet holes may be shorter than a distance between the second edges and the fluid outlet holes.

Other aspects and preferred embodiments of the disclosure are discussed below.

The above and other features of the disclosure are discussed below.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a perspective view of a conventional fuel cell stack structure;

FIG. 2 is a front view of a fuel cell separator structure according to one embodiment of the present disclosure;

FIGS. 3A to 3D show shapes of edges of a fuel cell separator and fluid flows depending on the edge shapes according to various embodiments of the present disclosure, respectively;

FIGS. 4A and 4B are front views of inner surfaces of a pair of separators facing gas diffusers according to one embodiment of the present disclosure; and

FIG. 4C is a projective view of the pair of separators when stacked according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION OF ILLUSTRATIVE EMBODIMENTS

Hereinafter, reference will be made in detail to various embodiments of the present disclosure, examples of which are shown in the accompanying drawings and described below. The present disclosure is not limited to the following embodiments, and the embodiments of the present disclosure may be implemented in various different forms. The embodiments are provided to make the description of the present disclosure thorough and to fully convey the scope of the present disclosure to those skilled in the art.

In the following description with reference to the accompanying drawings, identical or corresponding components are given the same reference numerals, and redundant descriptions thereof will be omitted.

In addition, in the following description of the embodiments, it will be understood that the terms “…part”, “…portion”, “…unit”, etc. indicate units for processing functions or operations, and may be implemented as hardware, or a combination of software and hardware.

In addition, the terminology used herein is for the purpose of describing particular embodiments only and is not intended to be limiting. As used herein, singular expressions may be intended to include plural expressions as well, unless the context clearly indicates otherwise.

In addition, throughout the description, when a part is said to "include" a component, unless otherwise specifically stated, the part does not exclude other components but rather allows for inclusion of other components.

In addition, in the following description, a length direction refers to the horizontal direction extending leftward and rightward from a fuel cell stack structure.

Furthermore, in the following description, a width direction refers to the vertical direction extending upward and downward from the fuel cell stack structure.

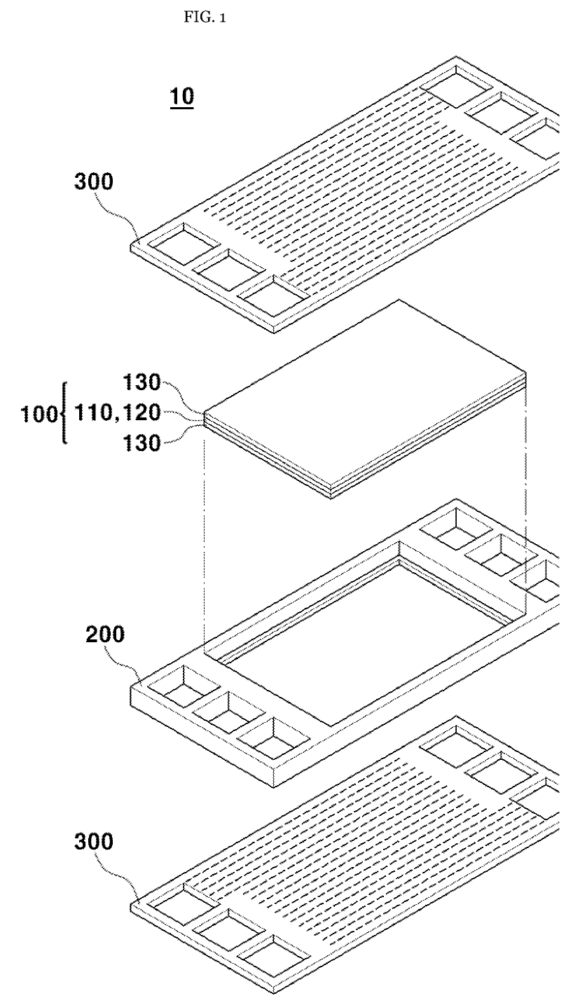

FIG. 1 is a perspective view of a conventional fuel cell stack structure 10.

The fuel cell stack structure 10 is formed as a structure in which a membrane electrode assembly 100, gas diffusers 130 laminated on both sides of the membrane electrode assembly 100, and separators 300 facing the gas diffusers 130 are stacked.

The membrane electrode assembly 100 is a component that generates electricity in a fuel cell stack, and is inserted into a frame 200 to be located therein. Furthermore, the membrane electrode assembly 100 includes an electrolyte membrane 110 and catalyst layers 120 located on both sides of the electrolyte membrane 110.

The electrolyte membrane 110 is located at the center of the membrane electrode assembly 100, and is bonded to the catalyst layers 120 disposed on both sides of the electrolyte membrane 110. In addition, the electrolyte membrane 110 is configured to support electrochemical reactions at a cathode and an anode, respectively. Further, the oxidation reaction of oxygen and hydrogen occurs through the electrolyte membrane 110, and electrons generated by the oxidation reaction flow through an external circuit to generate current.

Oxidation and reduction reactions occur in the catalyst layers 120 located on both sides of the electrolyte membrane 110 through bonding with the electrolyte membrane 110. In addition, the catalyst layers 120 include an anode catalyst layer 120 and a cathode catalyst layer 120 with the electrolyte membrane 110 therebetween. The anode catalyst layer 120 and the cathode catalyst layer 120 are located on both sides of the membrane electrode assembly 100 and are combined to the gas diffusers 130. Therethrough, oxygen and hydrogen flow into the catalyst layers 120 from the gas diffusers 130, thereby causing the electrochemical reactions.

At the anode catalyst layer 120, hydrogen comes into contact with the catalyst layer 120 and is decomposed into protons and electrons. Then, the protons travel to the cathode through the electrolyte membrane 110, and the electrons are transported to the cathode through an external circuit, generating current.

At the cathode catalyst layer 120, the electrons transported through the external circuit and the protons transported from the anode combine with oxygen to produce water. The water produced at the cathode catalyst layer 120 is discharged from the fuel cell to the outside.

The gas diffusers 130 disposed to face the membrane electrode assembly 100 are located on both surfaces of the membrane electrode assembly 100. The gas diffusers 130 are located in close contact with the membrane electrode assembly 100 and facilitate supply of gas and discharge of produced water through direct contact with the catalyst layers 120. In addition, the gas diffusers 130 form an electrical connection through bonding with the membrane electrode assembly 100, thereby assisting in conductivity between the membrane electrode assembly 100 and the separators 300.

In addition, the gas diffusers 130 include carbon fiber or carbon paper, and a porous carbon material provides electrical conductivity and simultaneously performs a structural role of transporting gas and discharging the produced water.

In some embodiments, the gas diffusers 130 transport oxygen and hydrogen to a reaction unit through a fine porous structure thereof. Gas introduced into the gas diffusers 130 diffuses into the catalyst layers 120 through pores of the gas diffusers 130 to be supplied to the catalyst layers 120. The porous structure of the gas diffusers 130 utilizes differences in gas pressure and concentration to allow oxygen and hydrogen to diffuse throughout the reaction unit, thereby assisting in the proper reaction of the fuel cell.

In addition, the gas diffusers 130 discharge the produced water generated through the reduction reaction at the cathode catalyst layer 120 to the outside. The produced water may be discharged to the outside through the porous structure of the gas diffusers 130. That is, the produced water obtained through the reduction reaction at the cathode is generated in the cathode catalyst layer 120, moves through the pores of the gas diffuser 130 and is discharged to the outside, or is discharged to the outside through a plurality of channels formed in the separator 300.

A pair of separators 300 located on outer surfaces of the gas diffusers 130 to face the outer surfaces of the gas diffusers 130 supplies a fluid to the gas diffusers 130 and discharges the water produced through the reduction reaction through manifolds 310 located at both ends of each of the separators 300.

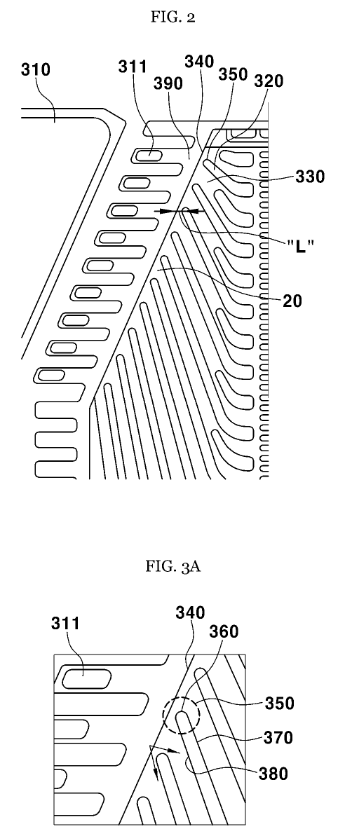

FIG. 2 is a front view of the structure of a fuel cell separator 300 according to one embodiment of the present disclosure.

In one embodiment of the present disclosure, each of a pair of separators 300 includes at least one manifold 310 located at both ends of the separator 300 in the width direction so that a fluid flows through the at least one manifold 310, fluid inlet holes 311 located adjacent to the at least one manifold 310 in the separator 300, a mount portion 390 on which a gasket inserted into the inner surface of the separator 300 is mounted, channels 330 fluidly connected to the fluid inlet holes 311, and lands 320 located between the channels 330.

The at least one manifold 310 through which the fluid flows may be located at the upper and lower ends of each of both sides of the separator 300. In some embodiments, the at least one manifold 310 may include a fluid inlet 313, into through which the fluid is introduced, and a fluid outlet 314, from which the fluid is discharged.

The fluid inlet 313 and the fluid outlet 314 are located diagonally with respect to the center of the separator 300. Therefore, the fluid introduced into the fluid inlet 313 flows within the separator 300 and is discharged from the fluid outlet 314 located diagonally to the fluid inlet 313. At this time, the fluid introduced through the manifold 310 refers to gas that causes a reduction-oxidation reaction, i.e., oxygen or hydrogen.

The fluid inlet holes 311 into which the fluid is introduced are located adjacent to the fluid inlet 313, and are located inside the fluid inlet 313. In addition, the fluid inlet holes 311 are fluidly connected to the fluid inlet 313, so that the fluid introduced through the fluid inlet 313 flows into the fluid inlet holes 311. In some embodiments, the fluid having passed through the fluid inlet 313 may flow into the fluid inlet holes 311 along the outer surface of the separator 300.

In addition, the fluid inlet holes 311 may be configured to extend inward from both sides of the separator 300 in the length direction.

The channels 330 located to face the fluid inlet holes 311 are located on the separator 300. Furthermore, the channels 330 are fluidly connected to the fluid inlet holes 311 so that the fluid having flowed through the fluid inlet holes 311 may flow into the channels 330. The fluid flowing into the channels 330 flows toward the gas diffuser 130. The lands 320 located between the respective channels 330 are configured to make surface contact with the gas diffuser 130.

A core 20 is located to face at least one manifold 310 is located to surround the channels 330 and the lands 320. Here, the core 20 is an area where the separator 300 faces the gasket, and is configured such that a step in the height direction is formed in a direction in which the fluid is introduced, and the core 20 may include a hexagonal or octagonal shape. In addition, a boundary 340 may be provided in an area adjacent to the core 20. In some embodiments, the boundary 340 refers to a boundary line of an end of an area where the fluid introduced through the fluid inlet holes 311 comes into contact with the core 20. Furthermore, the boundary 340 refers to an extension of the separator 300 corresponding to the edge of the gas diffuser 130. That is, the boundary 340 may be set based on an edge area corresponding to the gas diffuser 130, and ends of the lands 320 may protrude outward from the boundary 340 to be located adjacent to the fluid inlet holes 311.

The lands 320 located to face the boundary 340 include edges 350 at both ends thereof that branch off the fluid introduced through the fluid inlet holes 311.

The edges 350 include first edges 351 located adjacent to the fluid inlet 313 and second edges 352 located adjacent to the fluid outlet 314. The first edge 351 may be located at one end of each of the lands 320, and the second edge 352 may be located at the other end of each of the lands 320.

In addition, the edges 350 are configured such that each edge 350 branches off the gas having flowed into a corresponding one of the fluid inlet holes 311 into two channels 330 adjacent to the edge 350 by a set flow rate.

That is, the fluid having flowed through the fluid inlet holes 311 branches along the shape of the edges 350, and the flow rate of the fluid flowing along the edges 350 varies depending on the shape of the edges 350.

The edge 350 may include a curved portion 360 located at the end of the edge 350 and having a predetermined curvature value, a first extension 370 extending from one side of the curved portion 360 toward the upper end of the land 320, and a second extension 380 extending from the other side of the curved portion 360 toward the lower end of the land 320.

The curved portion 360 is located at the end of the edge 350 to protrude outward from the boundary 340. Furthermore, the curvature of the curved portion 360 is defined as the reciprocal of the radius of a curve (1/R). Here, the radius R of the curved portion 360 refers to a distance from the center of the curved portion 360 to one end of the curved portion 360.

When the curvature value is small, the radius R of the curved portion 360 is large, and thus the curved portion 360 has a gentle shape.

On the other hand, when the curvature value is large, the radius R of the curved portion 360 is small, and thus the curved portion 360 has a steep shape.

A vortex phenomenon occurs and increases through the curved portion 360 during fluid flow. That is, when the curvature value at the end of the curved portion 360 is small, the introduced fluid flow rate is greater than when the curvature value is large.

The first extension 370 connected to one side of the curved portion 360 extends from one end of the curved portion 360 toward the upper end of the land 320 and has a shape that is structurally continuous with the curved portion 360. The first extension 370 may include a first inclined portion 371 that extends along the curvature of the curved portion 360 toward the upper end of the land 320. Furthermore, the first inclined portion 371 may be inclined so as to be parallel to the flow direction of the gas flowing into the channels 330.

The second extension 380 connected to the other side of the curved portion 360 extends from the other end of the curved portion 360 toward the lower end of the land 320. Furthermore, the second extension 380 is configured to have a shape that is structurally continuous with the curved portion 360. The second extension 380 may include a second inclined portion 381 that extends along the curvature of the curved portion 360 toward the lower end of the land 320. Furthermore, the second inclined portion 381 may be inclined to face the flow direction of the gas flowing into the channel 330.

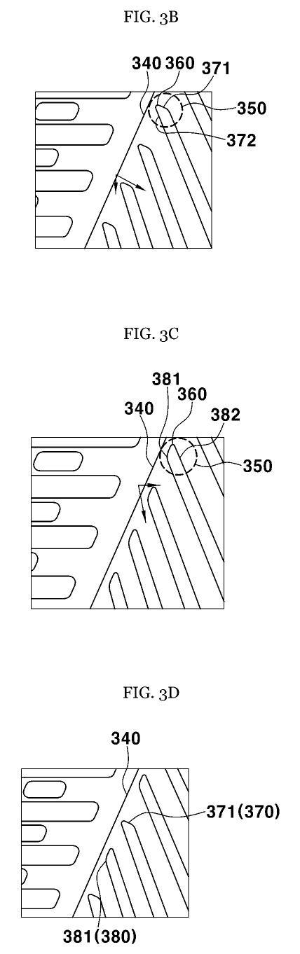

FIG. 3A shows a shape of the edges 350 of the fuel cell separator 300 and fluid flow depending on the edge shape according to one embodiment of the present disclosure.

In one embodiment of the present disclosure, the edge 350 may include a curved portion 360, a first extension 370, and a second extension 380, which are formed in a round shape having a predetermined curvature.

For example, the edge 350 may be formed in a round shape with the same radius from the central point of the edge 350. Furthermore, the edge 350 may include the curved portion 360 having a predetermined curvature, and the first extension 370 and the second extension 380 having the same curvature as the curved portion 360.

The curved portion 360 is located at the center of the edge 350 and is designed to change the flow direction of the flow when the fluid moves from the flow inlet hole 311 to the edge 350 via the boundary 340. The curved portion 360 is located at a position closest to the boundary 340.

The first extension 370 connected to one end of the curved portion 360 extends from the end of the curved portion 360 toward the upper end of the land 320, and forms a continuous shape with the curved portion 360.

The second extension 380 connected to the other end of the curved portion 360 extends from the other end of the curved portion 360 toward the lower end of the land 320, and may be formed symmetrically with the first extension 370 with respect to the curved portion 360.

In addition, the first extension 370 and the second extension 380 are designed to have the same curvature value as the curved portion 360. Furthermore, the first extension 370 and the second extension 380 are configured so that the fluid introduced through the fluid inlet hole 311 may branch off through the curved portion 360 and then branch off into the channels 330 at the same flow rate along the first extension 370 and the second extension 380.

As another example, the curved portion 360, the first extension 370, and the second extension 380 may be formed in round shapes having different curvature values. In addition, the edges 350 including the curved portion 360, the first extension 370, and the second extension 380 having the different curvature values, may be arranged alternately. In addition, the edges 350 may be configured to diverge the flow rate of the introduced fluid differently depending on the shape thereof, and the shape of the edges 350 is not limited to the above embodiment.

FIGS. 3B to 3D show shapes of the edges 350 and fluid flows depending on the edge shapes according to other embodiments of the present disclosure.

In another embodiment of the present disclosure, as shown in FIG. 3B, the edge 350 includes a curved portion 360 located adjacent to the lower end of the land 320, a first extension 370 extending from one end of the curved portion 360 toward the upper end of the land 320 at a predetermined angle of inclination, and a second extension 380 extending from the other end of the curved portion 360 toward the lower end of the land 320.

The curved portion 360 located adjacent to the lower end of the land 320 is configured to have a smaller radius from the central point of the edge 350 than the rounded curved portion 360 shown in FIG. 3A, and thus has a greater curvature value than the rounded curved portion 360.

When the curvature value is large, the end of the curved portion 360 has a steep slope and is located closer to the boundary 340 than when the curvature value is small.

Therefore, a distance between the boundary 340 and the end of the curved portion 360 when the curvature value of the curved portion 360 is large is shorter than the distance between the boundary 340 and the end of the curved portion 360 when the curvature value is small. When the distance between the boundary 340 and the end of the curved portion 360 is short, the cross-sectional area of a path in which the fluid flows decreases and results in flow resistance, and accordingly, the flow rate of the fluid flowing along the upper end of the land 320 increases compared to the fluid flowing along the lower end of the land 320.

The first extension 370 connected to one end of the curved portion 360 may include a first inclined portion 371 extending along the curved portion 360 to the upper end of the land 320. The first inclined portion 371 may be inclined to be parallel to the flow direction of gas flowing into the channels 330. Furthermore, the first inclined portion 371 may be inclined so as to gradually extend from the end of the edge 350 to the upper end of the edge 350.

The second extension 380 connected to the other end of the curved portion 360 may be configured as a first connection portion 372 extending along the curvature of the curved portion 360 to the lower end of the land 320. In addition, one end of the first connection portion 372 is located farther away from the boundary 340 than one end of the first inclined portion 371, and a distance between the first connection portion 372 and the boundary 340 is longer than a distance between the first inclined portion 371 and the boundary 340. Therefore, the amount of the fluid flowing along the first connection portion 372 is smaller than the amount of the fluid flowing along the first inclined portion 371.

That is to say, among the fluid flowing into the channels 330, a greater amount of the fluid flows to the upper end of the land 320 than the lower end of the land 320 due to the configuration and shape of the edges 350, and accordingly, the flow rate of the fluid flowing along the upper end of the land 320 increases.

In another embodiment of the present disclosure, as shown in FIG. 3C, the edge 350 includes a curved portion 360 located adjacent to the upper end of the land 320, a first extension 370 extending from one end of the curved portion 360 toward the upper end of the land 320, and a second extension 380 extending from the other end of the curved portion 360 toward the lower end of the land 320 at a predetermined angle of inclination.

The curved portion 360 located adjacent to the upper end of the land 320 is configured to have a smaller radius from the central point of the edge 350 than the rounded curved portion 360 shown in FIG. 3A. Therefore, the curved portion 360 according to this embodiment of the present disclosure is designed to have a greater curvature value than the rounded curved portion 360.

When the curvature value of the curved portion 360 is large, the curved portion 360 is located farther away from the boundary 340 than when the curvature is small.

The second extension 380 connected to the other end of the curved portion 360 includes a second inclined portion 381 extending toward the lower end of the land 320 along the curvature of the curved portion 360 at the predetermined angle of inclination. The second inclined portion 381 is inclined so as to face the flow direction of the gas flowing into the channels 330. Furthermore, the second inclined portion 381 is configured to be inclined downward with respect to one end of the edge 350 in the height direction, and accordingly, the area of the land 320 may be increased as the end of the edge 350 including the second inclined portion 381 moves along the channel 330.

The first extension 370 connected to one end of the curved portion 360 may include a second connection portion 382 extending toward the lower end of the land 320 along the curvature of the curved portion 360. Additionally, a distance between one end of the second connection portion 382 and the fluid inlet hole 311 may be shorter than a distance between the edge 350 including the first inclined portion 371 and the fluid inlet hole 311. Therefore, the amount of the fluid flowing into the channel 330 adjacent to the second connection portion 382 along the second connection portion 382 becomes smaller than the amount of the fluid flowing into the channel 330 adjacent to the second inclined portion 381.

Therefore, among the fluid flowing into the channels 330, the amount of the fluid flowing into the channel 330 located at the lower end of the land 320 is greater than the amount of the fluid flowing into the channel 330 located at the upper end of the land 320.

In another embodiment of the present disclosure, as shown in FIG. 3D, edges 350 having different shapes may be alternately arranged on a single separator 300. Furthermore, the edges 350, each of which has the first inclined portion 371, and the edges 350, each of which has the second inclined portion 381, may be alternately arranged.

In addition, the edge 350 having the first inclined portion 371 includes the first connection portion 372, and the edge 350 having the second inclined portion 381 includes the second connection portion 382.

In addition, the first inclined portion 371 and the second inclined portion 381 may be arranged to face each other, and the first connection portion 372 and the second connection portion 382 may be arranged to face both sides of the channel 330.

As described above, a channel inlet including the first inclined portion 371 and the second inclined portion 381 may be configured to have a wider space than the internal space of the channel 330. Accordingly, among the fluid flowing into the channels 330, a larger amount of the fluid flows between the first inclined section 371 and the second inclined section 381, and a smaller amount of the fluid flows between the first connection section 372 and the second connection section 382 than the amount of the fluid flowing between the first inclined section 371 and the second inclined section 381.

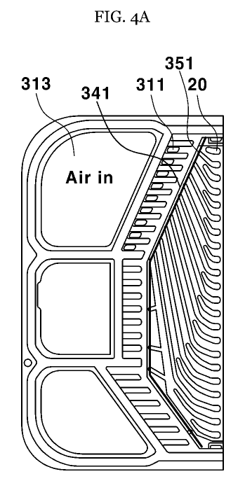

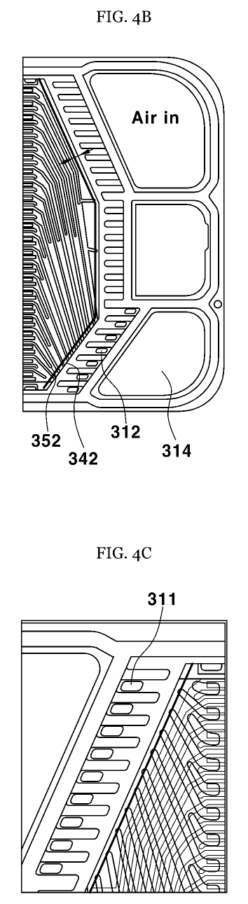

FIGS. 4A and 4B are front views of inner surfaces of the pair of separators 300 facing the gas diffusers according to one embodiment of the present disclosure, and FIG. 4C is a projective view of the pair of separators 300 when stacked according to one embodiment of the present disclosure.

The boundary 340 denotes an edge region of the separator that faces the gas diffuser, and includes a first boundary surface 341 extending along an inlet-side edge and a second boundary surface 342 extending along an outlet-side edge. The first boundary surface 341 is formed along the fluid inlet 313 and an inlet-side region adjacent thereto, and the second boundary surface 342 is formed along the fluid outlet 314 and an outlet-side region adjacent thereto. Furthermore, the first edges 351 are located to protrude toward the fluid inlet holes 311 along the first boundary surface 341, and the second boundary surface 342 includes second edges 352 that protrudes outward from the second boundary surface 342 in areas adjacent to the fluid outlet holes 312.

As shown in these figures, the fluid inlet holes 311 and a boundary surface of the core 20 may be located adjacent to each other. Moreover, a shortest distance between the boundary surface of the core 20 and the fluid inlet holes 311 is shorter than a shortest distance between the fluid outlet holes 312 and a boundary surface of the core 20 adjacent thereto. Furthermore, the core 20 and the first edges 351 may be located to be spaced apart by a distance of “L”, as shown in FIG. 2.

That is, a distance between the boundary surface of the core 20 adjacent to the fluid inlet holes 311 and the first edges 351 is longer than a distance between the boundary surface of the core 20 adjacent to the fluid outlet holes 312 and the second edges 352.

Therefore, as shown in FIG. 4C, when a pair of separators 300 is assembled with the membrane electrode assembly 100 therebetween, the boundary surface of the core 20 adjacent to the fluid inlet holes 311 formed in one of the pair of separators 300 is located to be spaced apart from the boundary surface of the core adjacent to the fluid inlet holes 311 formed in the other separator 300.

In summary, the present disclosure provides a technical feature that allows the edges 350 from the boundary 340 adjacent to the fluid inlet holes 311 to secure a space where the fluid inlet holes 311 are blocked by a tolerance between the gas diffuser 130 and the fluid inlet 313, and controls the flow rate of the fluid flowing into the channels 330 through the shape of the edges 350.

As is apparent from the above description, the present disclosure may obtain the following effects through the configuration and the combination and usage relations described in the above embodiments.

First, the boundary between fluid inlet holes and channels is optimized and edges at the ends of lands are designed to have various shapes, thus being capable of preventing flow separation from occurring at the fluid inlet holes and enhancing uniformity of fluid flow. Therethrough, the performance and efficiency of a fuel cell stack may be significantly improved.

Second, the curvature and angle of inclination of the edges are adjusted so that a fluid may naturally flow into the channels, thus being capable of minimizing resistance due to flow separation and stabilizing inlet pressure. Therethrough, an increase of differential pressure of the fuel cell stack may be prevented, and the durability of the fuel cell stack may be enhanced.

Third, a fluid flow path is optimized by arranging the fluid inlet holes adjacent to the boundary, thus being capable of inducing uniform fluid distribution within the stack and improving mass transfer performance within the stack through reduction in losses due to flow separation. Therethrough, stable operation of the fuel cell stack may be enabled, and performance degradation of the fuel cell stack during long-term use may be prevented.

The above detailed description is illustrative of the present disclosure. In addition, the above description is intended to illustrate the exemplary embodiments of the present disclosure, and the present disclosure may be used in various other combinations and modifications under various environments. That is, it should be apparent to those skilled in the art that various substitutions, changes and modifications which are not exemplified herein but are still within the spirit and scope of the present disclosure may be made. The described embodiments illustrate the best mode for implementing the technical idea of the present disclosure, and various changes required for specific application fields and uses of the present disclosure are also possible. Accordingly, the above detailed description of the disclosure is not intended to limit the present disclosure to the disclosed embodiments. In addition, the appended claims should be construed to include other embodiments.

What is claimed is:

1. A fuel cell separator structure, comprising:
a membrane electrode assembly;
a pair of separators disposed to face both side surfaces of the membrane electrode assembly;
at least one manifold located on each of the pair of separators so that gas flows through the at least one manifold;
fluid inlet holes located adjacent to the at least one manifold to be fluidly connected to the at least one manifold;
channels located such that one end of each of the channels faces a corresponding one of the fluid inlet holes; and
lands located between the channels and having edges located at ends thereof,
wherein the edges protrude adjacent to the fluid inlet holes based on a boundary configured to face each of gas diffusers of the membrane electrode assembly.

2. The fuel cell separator structure of claim 1, wherein the edges comprise:
first edges located at one end of each of the lands; and
second edges located at a remaining end of each of the lands.

3. The fuel cell separator structure of claim 2, wherein the first edges are located to face the fluid inlet holes.

4. The fuel cell separator structure of claim 2, wherein each of the first edges comprises:
a curved portion located at an end of each of the first edges and having a curvature value;
a first extension configured to extend from one side of the curved portion toward one side of a corresponding one of the lands; and
a second extension configured to extend from the other side of the curved portion toward the other side of the corresponding one of the lands.

5. The fuel cell separator structure of claim 4, wherein the first extension and the second extension have a predetermined curvature value.

6. The fuel cell separator structure of claim 4, wherein:
the first extension comprises a first inclined portion configured to extend to the one side of the corresponding one of the lands at a designated angle of inclination along a curvature of the curved portion, and
the first inclined portion is inclined to be parallel to a flow direction of gas flowing into the channels.

7. The fuel cell separator structure of claim 4, wherein the second extension comprises a second inclined portion configured to extend to the other side of the corresponding one of the lands at a designated angle of inclination along a curvature of the curved portion,
wherein the second inclined portion is inclined to face a flow direction of gas flowing into the channels.

8. The fuel cell separator structure of claim 7, wherein the lands are configured such that the first edges comprising a first inclined portion or the second inclined portion are arranged alternately.

9. The fuel cell separator structure of claim 2, wherein the at least one manifold comprises:
a fluid inlet configured such that a fluid is introduced thereinto; and
a fluid outlet located diagonally to the fluid inlet with respect to a separator of the pair of separators and configured such that the fluid is discharged from the fluid outlet,
wherein:
the fuel cell separator structure comprises fluid outlet holes located adjacent to the fluid outlet to be fluidly connected to the fluid outlet; and
the second edges are located to face the fluid outlet holes.

10. The fuel cell separator structure of claim 9, wherein a first distance between the first edges and the fluid inlet holes is shorter than a second distance between the second edges and the fluid outlet holes.

11. The fuel cell separator structure of claim 9, wherein the first edges are disposed to be spaced apart from the boundary by a predetermined distance, and the second edges are located adjacent to the boundary.

12. A fuel cell separator structure, comprising:
a membrane electrode assembly;
a separator disposed to face a side surface of the membrane electrode assembly;
a manifold located on the separator so that a gas flows through the manifold;
a fluid inlet hole located adjacent to the manifold to be fluidly connected to the manifold;
a channel comprising a channel end facing the fluid inlet hole; and
a land located between the channel and a second channel of the fuel cell separator structure, the land comprising:
a first edge located at a first land end of the land and facing the fluid inlet hole; and
a second edge located at a second end of the land.

13. The fuel cell separator structure of claim 12, wherein the first edge comprises:
a curved portion having a first curvature value;
a first extension extending from a first curved portion side of the curved portion toward a first land side of the land; and
a second extension extending from a second curved portion side of the curved portion toward a second land side of the land.

14. The fuel cell separator structure of claim 13, wherein the first extension and the second extension each have a second curvature value.

15. The fuel cell separator structure of claim 13, wherein:
the first extension comprises an inclined portion extending to the first land side of the land at a designated angle of inclination along a curvature of the curved portion, and
the inclined portion is inclined to be parallel to a flow direction of a portion of the gas flowing into the channel.

16. The fuel cell separator structure of claim 13, wherein:
the second extension comprises an inclined portion extending to the second land side of the land at a designated angle of inclination along a curvature of the curved portion, and
the inclined portion is inclined to face a flow direction of a portion of the gas flowing into the channel.

17. The fuel cell separator structure of claim 12, wherein the manifold comprises:
a fluid inlet configured to allow introduction of a fluid; and
a fluid outlet located diagonally to the fluid inlet with respect to the separator and configured to allow the fluid to discharge from the fluid outlet.

18. The fuel cell separator structure of claim 17, further comprising:
a fluid outlet hole located adjacent to the fluid outlet and fluidly connected to the fluid outlet.

19. The fuel cell separator structure of claim 18, wherein the second edge faces the fluid outlet hole.

20. The fuel cell separator structure of claim 19, wherein a first distance between the first edge and the fluid inlet hole is shorter than a second distance between the second edge and the fluid outlet hole.
